(19) United States
(12) Patent Application Publication
(10) Pub. No.: US 2023/0094825 A1
(43) Pub. Date: Mar. 30, 2023

(54) MOTION VECTOR DIFFERENCE SIGN PREDICTION FOR VIDEO CODING

(71) Applicant: QUALCOMM Incorporated, San Diego, CA (US)

(72) Inventors: Yan Zhang, San Diego, CA (US); Bappaditya Ray, San Diego, CA (US); Vadim Seregin, San Diego, CA (US); Marta Karczewicz, San Diego, CA (US)

(21) Appl. No.: 17/929,122

(22) Filed: Sep. 1, 2022

Related U.S. Application Data
(60) Provisional application No. 63/249,421, filed on Sep. 28, 2021.

(51) Int. Cl. H04N 19/137; H04N 19/88; H04N 19/176

(52) U.S. Cl. CPC H04N 19/137; H04N 19/88; H04N 19/176

(57) ABSTRACT

A video decoder may be configured to construct motion vector candidates using possible sign values, respective magnitudes of motion vector difference components, and a motion vector predictor for a block of video data, wherein the possible sign values include a positive sign value and a negative sign value, sort the motion vector candidates based on a cost for each of the motion vector candidates to create a sorted list, determine a respective motion vector difference sign for each motion vector difference coordinate based on a motion vector sign predictor index and the sorted list, and decode the block of video data using the respective magnitudes of motion vector difference coordinates and the respective motion vector difference sign for each motion vector difference component.

This application claims the benefit of U.S. Provisional Patent Application No. 63/249,421, filed Sep. 28, 2021, the entire content of which is incorporated by reference herein.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), ITU-T H.266/Versatile Video Coding (VVC), and extensions of such standards, as well as proprietary video codecs/formats such as AOMedia Video 1 (AV1) that was developed by the Alliance for Open Media. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques inter prediction and inter-related information coding. More specifically, devices and techniques for predicting the sign of an MVD (motion vector difference) are described. An MVD is the difference between a motion vector determined for a particular coding mode and a motion vector that is predicted using a particular motion vector prediction method. The MVD may be represented by the difference between the determined motion vector and the predicted motion vector in both the X and Y directions (e.g., called the motion vector difference coordinates).

An MVD may include both the absolute value of the difference (e.g., the magnitude) as well as the polarity or sign of the difference (e.g., positive or negative). Signaling information that indicates the sign of an MVD coordinate may consume a large amount of bandwidth in the overhead signaling. This disclosure describes techniques for predicting the sign of MVD coordinates for one or more coding modes that uses an MVD. For example, the techniques of this disclosure may be used for MVDs generated in a merge mode with MVD (MMVD) coding mode, an affine MMVD, a geometric partitioning mode (GPM) with MMVD, a multi-hypothesis prediction (MHP) mode, or other coding modes where it may be beneficial to predict the sign of an MVD or other motion vector. The techniques of this disclosure may improve the coding efficiency of such coding modes.

In one example, this disclosure describes a method of decoding video data, the method comprising constructing motion vector candidates using possible sign values, respective magnitudes of motion vector difference components, and a motion vector predictor for a block of video data, wherein the possible sign values include a positive sign value and a negative sign value, sorting the motion vector candidates based on a cost for each of the motion vector candidates to create a sorted list, determining a respective motion vector difference sign for each motion vector difference coordinate based on a motion vector sign predictor index and the sorted list, and decoding the block of video data using the respective magnitudes of motion vector difference coordinates and the respective motion vector difference sign for each motion vector difference component.

In another example, this disclosure describes an apparatus configured to decode video data, the apparatus comprising a memory configured to store a block of video data, and one or more processors in communication with the memory, the one or more processors configured to construct motion vector candidates using possible sign values, respective magnitudes of motion vector difference components, and a motion vector predictor for a block of video data, wherein the possible sign values include a positive sign value and a negative sign value, sort the motion vector candidates based on a cost for each of the motion vector candidates to create a sorted list, determine a respective motion vector difference sign for each motion vector difference coordinate based on a motion vector sign predictor index and the sorted list, and decode the block of video data using the respective magnitudes of motion vector difference coordinates and the respective motion vector difference sign for each motion vector difference component.

In another example, this disclosure describes an apparatus configured to decode video data, the apparatus comprising means for constructing motion vector candidates using possible sign values, respective magnitudes of motion vector difference components, and a motion vector predictor for a block of video data, wherein the possible sign values include a positive sign value and a negative sign value, means for sorting the motion vector candidates based on a cost for each of the motion vector candidates to create a sorted list, means for determining a respective motion vector difference sign for each motion vector difference coordinate based on a motion vector sign predictor index and the sorted list, and means for decoding the block of video data using the respective magnitudes of motion vector difference coordinates and the respective motion vector difference sign for each motion vector difference component.

In another example, this disclosure describes a non-transitory computer-readable storage medium storing instructions that, when executed, cause one or more processors configured to decode video data to construct motion vector candidates using possible sign values, respective magnitudes of motion vector difference components, and a motion vector predictor for a block of video data, wherein the possible sign values include a positive sign value and a negative sign value, sort the motion vector candidates based on a cost for each of the motion vector candidates to create a sorted list, determine a respective motion vector difference sign for each motion vector difference coordinate based on a motion vector sign predictor index and the sorted list, and decode the block of video data using the respective magnitudes of motion vector difference coordinates and the respective motion vector difference sign for each motion vector difference component.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIG. 2 is a conceptual diagram illustrating an example simplified affine motion model.

FIG. 3 is a conceptual diagram illustrating an example merge mode with motion vector difference (MMVD) search point.

FIG. 4 is a conceptual diagram illustrating examples of geometric partitioning mode (GPM) splits grouped by identical angles.

FIG. 5 illustrates example frequency responses of two interpolation filters.

FIG. 6 is a conceptual diagram illustrating an example of template matching performed on a search area around an initial motion vector.

FIG. 7 is a conceptual diagram illustrating an example of motion vector sign prediction on translational inter block using template matching.

FIG. 8 is a block diagram illustrating an example video encoder that may perform the techniques of this disclosure.

FIG. 9 is a block diagram illustrating an example video decoder that may perform the techniques of this disclosure.

FIG. 10 is a flowchart illustrating an example method for encoding a current block in accordance with the techniques of this disclosure.

FIG. 11 is a flowchart illustrating an example method for decoding a current block in accordance with the techniques of this disclosure.

FIG. 12 is a flowchart illustrating another example method for decoding a current block in accordance with the techniques of this disclosure.

### DETAILED DESCRIPTION

Various coding modes, such as inter prediction, use motion vectors to determine a predictive block. In some examples, rather than signaling the coordinates of a motion vector, a video encoder may signal an MVD (motion vector difference). An MVD is the difference between a motion vector determined for a particular coding mode and a motion vector that is predicted using a particular motion vector prediction method. The MVD may be represented by the difference between the determined motion vector and the predicted motion vector in both the X and Y directions (e.g., called the motion vector difference coordinates).

An MVD may include both the absolute value of the difference (e.g., the magnitude) as well as the polarity or sign of the difference (e.g., positive or negative). Signaling information that indicates the sign of an MVD coordinate may consume a large amount of bandwidth in the overhead signaling. This disclosure describes techniques for predicting the sign of MVD coordinates for one or more coding modes that uses an MVD. For example, the techniques of this disclosure may be used for MVDs generated in a merge mode with MVD (MMVD) coding mode, an affine MMVD, a geometric partitioning mode (GPM) with MMVD, a multi-hypothesis prediction (MHP) mode, or other coding modes where it may be beneficial to predict the sign of an MVD or other motion vector. The techniques of this disclosure may improve the coding efficiency of such coding modes.

In one example of the disclosure, a video decoder may be configured to construct motion vector candidates using possible sign values, respective magnitudes of motion vector difference components, and a motion vector predictor for a block of video data, wherein the possible sign values include a positive sign value and a negative sign value, sort the motion vector candidates based on a cost for each of the motion vector candidates to create a sorted list, determine a respective motion vector difference sign for each motion vector difference coordinate based on a motion vector sign predictor index and the sorted list, and decode the block of video data using the respective magnitudes of motion vector difference coordinates and the respective motion vector difference sign for each motion vector difference component.

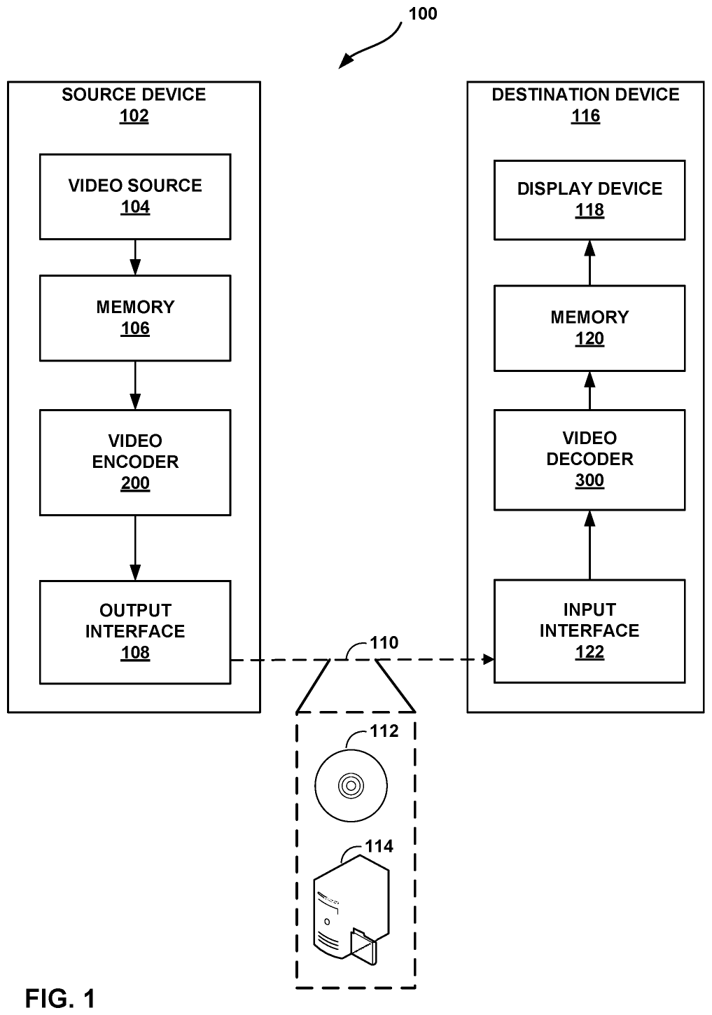

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, unencoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may comprise any of a wide range of devices, including desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for motion vector difference sign prediction. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques for motion vector difference sign prediction. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, unencoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (eMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder, and may include appropriate MUX-DEMUX units, or other hardware and/or software, to handle multiplexed streams including both audio and video in a common data stream.

Video encoder 200 and video decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may comprise an integrated circuit, a microprocessor, and/or a wireless communication device, such as a cellular telephone.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). In other examples, video encoder 200 and video decoder 300 may operate according to a proprietary video codec/format, such as AOMedia Video 1 (AV1), extensions of AV1, and/or successor versions of AV1 (e.g., AV2). In other examples, video encoder 200 and video decoder 300 may operate according to other proprietary formats or industry standards. The techniques of this disclosure, however, are not limited to any particular coding standard or format. In general, video encoder 200 and video decoder 300 may be configured to perform the techniques of this disclosure in conjunction with any video coding techniques that use motion vector difference sign prediction.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of coding tree units (CTUs). Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to coding units (CUs).

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

When operating according to the AV1 codec, video encoder 200 and video decoder 300 may be configured to code video data in blocks. In AV1, the largest coding block that can be processed is called a superblock. In AV1, a superblock can be either 128×128 luma samples or 64×64 luma samples. However, in successor video coding formats (e.g., AV2), a superblock may be defined by different (e.g., larger) luma sample sizes. In some examples, a superblock is the top level of a block quadtree. Video encoder 200 may further partition a superblock into smaller coding blocks. Video encoder 200 may partition a superblock and other coding blocks into smaller blocks using square or non-square partitioning. Non-square blocks may include N/2×N, N×N/2, N/4×N, and N×N/4 blocks. Video encoder 200 and video decoder 300 may perform separate prediction and transform processes on each of the coding blocks.

AV1 also defines a tile of video data. A tile is a rectangular array of superblocks that may be coded independently of other tiles. That is, video encoder 200 and video decoder 300 may encode and decode, respectively, coding blocks within a tile without using video data from other tiles. However, video encoder 200 and video decoder 300 may perform filtering across tile boundaries. Tiles may be uniform or non-uniform in size. Tile-based coding may enable parallel processing and/or multi-threading for encoder and decoder implementations.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning, QTBT partitioning, MTT partitioning, superblock partitioning, or other partitioning structures.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component is an array or single sample from one of the three arrays (luma and two chroma) that compose a picture in 4:2:0, 4:2:2, or 4:4:4 color format or the array or a single sample of the array that compose a picture in monochrome format. In some examples, a coding block is an M×N block of samples for some values of M and N such that a division of a CTB into coding blocks is a partitioning.

The blocks (e.g., CTUs or CUs) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile. The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may comprise N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

AV1 includes two general techniques for encoding and decoding a coding block of video data. The two general techniques are intra prediction (e.g., intra frame prediction or spatial prediction) and inter prediction (e.g., inter frame prediction or temporal prediction). In the context of AV1, when predicting blocks of a current frame of video data using an intra prediction mode, video encoder 200 and video decoder 300 do not use video data from other frames of video data. For most intra prediction modes, video encoder 200 encodes blocks of a current frame based on the difference between sample values in the current block and predicted values generated from reference samples in the same frame. Video encoder 200 determines predicted values generated from the reference samples based on the intra prediction mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block. This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

The techniques of this disclosure are related to inter prediction and inter-related information coding. More specifically, this disclosure describes methods and devices for predicting the sign (e.g., the polarity) of a MVD (motion vector difference). The techniques of this disclosure may be applied to extensions of any of the existing video codecs, such as HEVC (High Efficiency Video Coding), and/or VVC (Versatile Video Coding), Essential Video Coding (EVC), or be an efficient coding tool in future video coding standards.

As will be explained in more detail below, in accordance with the techniques of this disclosure, video decoder 300 may be configured to construct motion vector candidates using possible sign values, respective magnitudes of motion vector difference coordinates, and a motion vector predictor for a block of video data, wherein the possible sign values include a positive sign value and a negative sign value, sort the motion vector candidates based on a cost for each of the motion vector candidates to create a sorted list, determine a motion vector difference sign based on a motion vector sign predictor index and the sorted list, and decode the block of video data using the magnitudes of motion vector difference coordinates and the motion vector difference sign.

In the following sections HEVC, JEM techniques, and works in VVC related to the techniques of this disclosure are reviewed.

MVD Sign Coding in VVC

In VVC and the currently developing Enhanced Compression Model (ECM) software, a video encoder (e.g., video encoder 200) may be configured to signal a motion vector difference (MVD) in a bitstream to a video decoder (e.g., video decoder 300). An MVD is the difference between a motion vector (MV) to be used to derive an inter predictor and its motion vector predictor (MVP). A MV, MVP, and MVD are vectors and have two components: a horizontal component (x) and a vertical component (y). When MVDx or MVDy is not equal to zero, video encoder 200 may signal the sign of the component (e.g., a syntax element that indicates positive or negative polarity). In some examples, the sign is signaled using CABAC bypass mode (e.g., not context coded, but coded with a fixed probability model).

Affine Motion Prediction in VVC

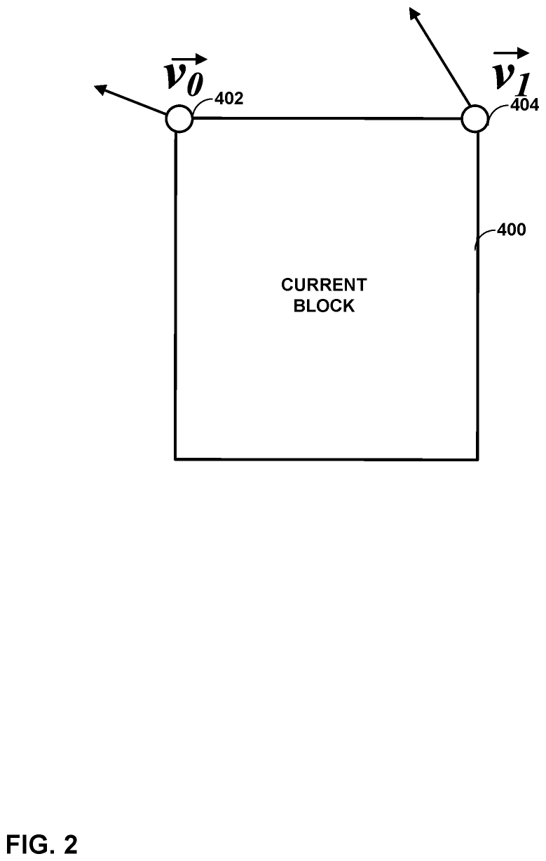

In HEVC, only a translational motion model is used for motion compensated prediction (MCP). In some examples, a translation motion model is used with so-called “regular inter prediction.” While in the real world, there are many kinds of motion, not just straight translational motion. Other types of motion may include zoom in/out, rotation, perspective motions, and the other irregular motions. In VVC, a simplified affine transform motion compensation prediction may be used to improve coding efficiency. FIG. 2 is a conceptual diagram illustrating an example simplified affine motion model. As shown in FIG. 2, the affine motion field of current block 400 is described by control point motion vectors 402 (vₒ) and 404 (v₁). In other examples, three control point motion vectors may be sued to define the motion.

Taking an affine motion model with two control point motion vectors as an example, the motion vector field (MVF) of a block is described by the following equation:

$$\{ \begin{matrix}{v}_{x} = \frac{( {v}_{1 x} - {v}_{0 x} )}{w} x - \frac{( {v}_{1 y} - {v}_{0 y} )}{w} y + {v}_{0 x} \\ {v}_{y} = \frac{( {v}_{1 y} - {v}_{0 y} )}{w} x + \frac{( {v}_{1 x} - {v}_{0 x} )}{w} y + {v}_{0 y}\end{matrix} , \qquad ( 1 )$$

where (v₀ₓ, v_{0y}) is the motion vector of the top-left corner control point, and (v₁ₓ, v_{1y}) is the motion vector of the top-right corner control point.

Merge Mode with MVD (MMVD)

In VVC and ECM, in addition to merge mode, where the implicitly derived motion information is directly used for the generation of prediction samples of the current CU, the merge mode with motion vector differences (MMVD) mode may also be used. Video encoder 200 may signal an MMVD flag after sending a regular merge flag to specify whether MMVD mode is used for a CU.

In MMVD, after a merge candidate is selected, the merge candidate is further refined by the signaled MVD information. A merge candidate includes the motion information of a neighboring block of the currently coded block. The video decoder may be configured to construct a list of merge candidates and may select the motion information related to the merge candidate indicated by the video encoder (e.g., by a merge index to the candidate list). The motion information may include a motion vector, a reference picture list, and a prediction direction.

The signaled MVD information includes a MMVD candidate flag, an index to specify motion magnitude, and an index that indicates motion direction. In MMVD mode, one of the first two candidates in the merge list is selected to be used as the starting MV. The MMVD candidate flag is signaled to specify which merge candidate is used between the first and second merge candidates.

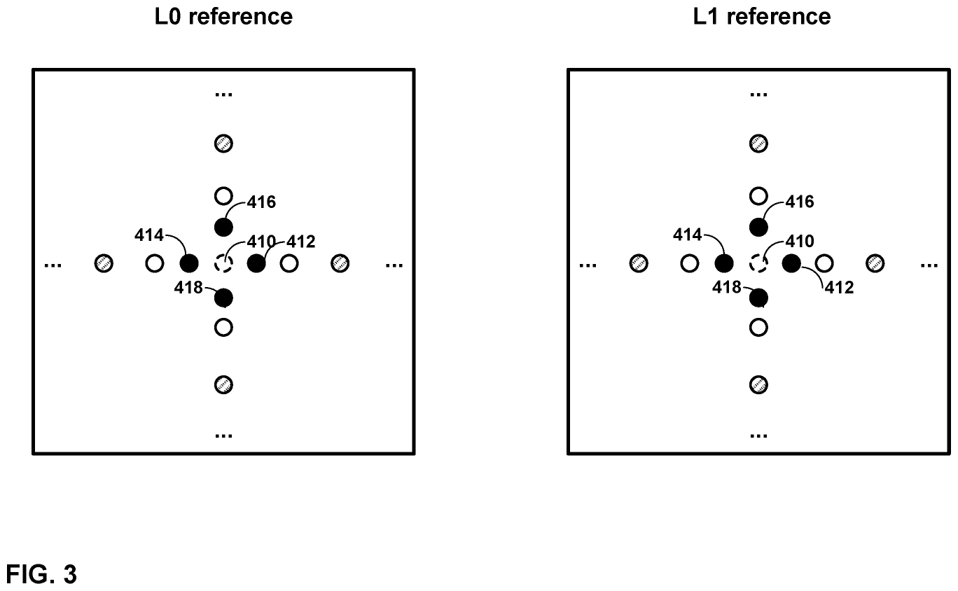

FIG. 3 is a conceptual diagram illustrating an example MMVD search point. In FIG. 3, location 410 is the location pointed to by the starting motion vector. For each of reference lists L0 and L1, locations 412 and 414 are determined by adding a positive or negative offset, respectively, to the x-coordinate of the starting motion vector. Locations 416 and 418 are determined by adding a positive or negative offset, respectively, to the y-coordinate of the starting motion vector. The other locations shown in FIG. 3 are determined in a similar fashion, but using larger offsets.

A distance index (Distance IDX) specifies motion magnitude information and indicates the pre-defined offset from the starting point (e.g., the starting MV). As shown in FIG. 3, an offset is added to either a horizontal component or a vertical component of the starting MV. One example of the relationship between the distance index and a pre-defined offset is specified in Table 1

TABLE 1
The relation of distance index and pre-defined offset

| | | | | | | | | |
|---|---|---|---|---|---|---|---|---|
| Distance | 0 | 1 | 2 | 3 | 4 | 5 | 6 | 7 |
| IDX | | | | | | | | |
| Offset (in | 1/4 | 1/2 | 1 | 2 | 4 | 8 | 16 | 32 |
| unit of | | | | | | | | |
| luma | | | | | | | | |
| sample) | | | | | | | | |

The direction index (Direction IDX) represents the direction (e.g., a positive sign or negative sign for magnitude) of the MVD relative to the starting point. The direction index can represent one of the four directions shown in Table 2 below. It is noted that the meaning of the MVD sign could be variable according to the information of the starting MVs. When the starting MVs is a uni-prediction MV or bi-prediction MVs with both lists pointing to the same side of the current picture (e.g., picture order counts (POCs) of two references are both larger than the POC of the current picture, or are both smaller than the POC of the current picture), then the sign in Table 2 specifies the sign of the MV offset added to the starting MV.

When the starting MVs are bi-prediction MVs with the two MVs pointing to different sides of the current picture (e.g., the POC of one reference is larger than the POC of the current picture, and the POC of the other reference is smaller than the POC of the current picture), and the difference of the POC in list 0 is greater than the POC in list 1, the sign in Table 2 specifies the sign of MV offset added to the list0 MV component of starting MV and the sign for the list1 MV has opposite value. Otherwise, if the difference of POC in list 1 is greater than list 0, the sign in Table 2 specifies the sign of MV offset added to the list1 MV component of starting MV and the sign for the list0 MV has opposite value.

The MVD is scaled according to the difference of POCs in each direction. If the differences of POCs in both lists are the same, no scaling is needed. Otherwise, if the difference of POC in list 0 is larger than the POC of list 1, the MVD for list 1 is scaled, by defining the POC difference of L0 as a variable td and POC difference of L1 as a variable tb. If the POC difference of L1 is greater than L0, the MVD for list 0 is scaled in the same way. If the starting MV is uni-predicted, the MVD is added to the available MV.

TABLE 2
Sign of MV offset specified by direction index

| | | | | |
|---|---|---|---|---|
| Direction IDX | 00 | 01 | 10 | 11 |
| x-axis | + | − | N/A | N/A |
| y-axis | N/A | N/A | + | − |

Affine MMVD

In ECM, MMVD may be further extended to be applied with affine inter prediction mode. In affine MMVD, as is done in regular inter MMVD, four directions are used to determine the MVD sign of each component of the MVD, and the corresponding MVD sign and direction index table is the same as Table 2 above. However, since affine inter prediction uses two or three control point motion vectors to determine the motion model of a single prediction direction, the same MVD is added to all the control point motion vectors (CPMVs) in order to reduce complexity. In the case of bi-prediction, if the two reference pictures are located temporally both before or after the current picture to be coded, the MVD used for the two reference lists will be identical. If the two reference pictures are located temporally on different sides with respect to the current picture, an MVD with the opposite value will be added to the CPMVs from reference list 1.

Geometric Partitioning Mode (GPM) with MMVD

In VVC, a geometric partitioning mode is supported for inter prediction. The geometric partitioning mode is signalled using a CU-level flag as one kind of merge mode, with other merge modes, including the regular merge mode, the MMVD mode, the combined inter/intra prediction (CIIP) mode, and the subblock merge mode. In total, 64 partitions are supported by GPM for each possible CU size: w×h=2^{m}×2ⁿ with m, n∈{3 . . . 6}, excluding 8×64 and 64×8.

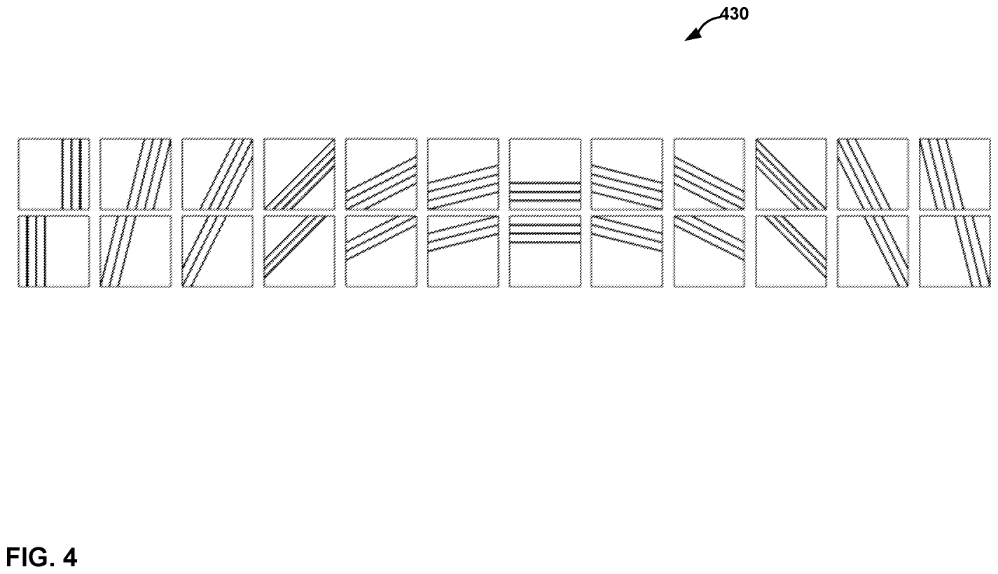

FIG. 4 is a conceptual diagram illustrating examples of GPM splits 430 grouped by identical angles. When GPM is used, a CU is split into two parts by a geometrically located straight line (see FIG. 4). The location of the splitting line is mathematically derived from an angle and offset parameters of a specific partition. Each part of a geometric partition in the CU is inter-predicted using its own motion information. In one example, only uni-prediction is allowed for each partition. For example, each partition has one motion vector and one reference index. The uni-prediction motion constraint is applied to ensure that, as in conventional bi-prediction, only two motion compensated predictions are needed for each CU.

If geometric partitioning mode is used for the current CU, then a geometric partition index indicating the partition mode of the geometric partition (angle and offset), and two merge indices (one for each partition), are further signalled. The maximum GPM candidate size is signalled explicitly in an SPS and specifies the syntax binarization for GPM merge indices. After predicting each part of the geometric partition, the sample values along the geometric partition edge are adjusted using blending processing with adaptive weights. This is the prediction signal for the whole CU, and transform and quantization process will be applied to the whole CU, as in other prediction modes.

In one example of ECM, GPM is further extended by applying motion vector refinement on top of the existing GPM uni-directional MVs. A flag is first signaled for a GPM CU to specify whether this motion vector refinement mode is used. If the motion vector refinement mode is used, video encoder 200 may determine for each geometric partition of a GPM CU whether to signal an MVD or not. If an MVD is signaled for a geometric partition, after a GPM merge candidate is selected, the motion of the partition is further refined by the signaled MVDs information. All other procedures are kept the same as in GPM.

The MVD is signaled as a pair of distance and direction, similar to that in MMVD. There are nine candidate distances (¼-pel, ½-pel, 1-pel, 2-pel, 3-pel, 4-pel, 6-pel, 8-pel, 16-pel), and eight candidate directions (four horizontal/vertical directions and four diagonal directions) involved in GPM with MMVD (GPM-MMVD).

Multi-Hypothesis Prediction (MHP)

In the multi-hypothesis inter prediction mode (see, e.g., M. Winken, et. al. “CE10: Multi-hypothesis inter prediction (Test 10.1.2),” Joint Video Experts Team (JVET) of ITU-T SG 16 WP 3 and ISO/IEC JTC 1/SC 29/WG 11, 13^{th} Meeting: Marrakech, Mass., 9-18 Jan. 2019, JVET-M0425), one or more additional motion-compensated prediction signals are signaled, in addition to the conventional bi prediction signal. The resulting overall prediction signal is obtained by sample-wise weighted superposition. With the bi-prediction signal p_{bi} and the first additional inter prediction signal/hypothesis h₃, the resulting prediction signal p₃ is obtained as follows:

p₃=(1−α)p_{bi}+αₕ₃

The weighting factor α is specified by the syntax element add_hyp_weight_idx, according to the following mapping:

| add_hyp_weight_idx | α |
|---|---|
| 0 | 1/4 |
| 1 | −1/8 |

Analogously to the above techniques, more than one additional prediction signal can be used. The resulting overall prediction signal is accumulated iteratively with each additional prediction signal.

pₙ₊₁=(1−αₙ₊₁)pₙ+αₙ₊₁hₙ₊₁

The resulting overall prediction signal is obtained as the last pₙ (e.g., the pₙ having the largest index n). In one example, up to two additional prediction signals can be used (e.g., n is limited to 2).

The motion parameters of each additional prediction hypothesis can be signaled either explicitly by specifying the reference index, the motion vector predictor index, and the motion vector difference, or implicitly by specifying a merge index. A separate multi-hypothesis merge flag may be used to distinguish between these two signalling modes.

In one example, for inter AMVP mode, MHP is only applied if non-equal weights in bi-prediction with CU-level weights (BCW) mode is selected in bi-prediction mode.

A combination of MHP and bi-directional optical flow (BDOF) coding is possible. However, in one example, BDOF is only applied to the bi-prediction signal part of the prediction signal (e.g., the ordinary first two hypotheses).

12-Tap Interpolation Filter

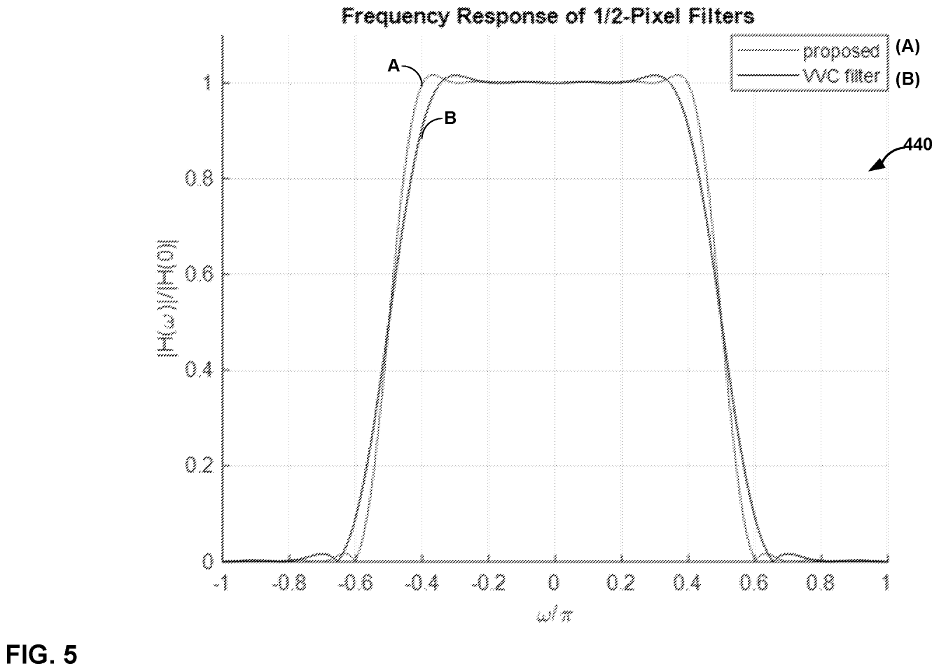

In this example, the 8-tap interpolation filter used in VVC is replaced with a 12-tap filter. The 12-tap interpolation filter is derived from the sinc function, of which the frequency response is cut off at the Nyquist frequency and cropped by a cosine window function. Table 3 gives the filter coefficients of all 16 phases. FIG. 5 shows a graph 440 that compares the frequency responses of the 12-tap interpolation filters (filter response A) with the VVC interpolation filter (filter response B), all at half-pel phase.

TABLE 3
Filter coefficients of the 12-tap interpolation filter

| | | | | | | | | | | | | |
|---|---|---|---|---|---|---|---|---|---|---|---|---|
| 1/16 | −1 | 2 | −3 | 6 | −14 | 254 | 16 | −7 | 4 | −2 | 1 | 0 |
| 2/16 | −1 | 3 | −7 | 12 | −26 | 249 | 35 | −15 | 8 | −4 | 2 | 0 |
| 3/16 | −2 | 5 | −9 | 17 | −36 | 241 | 54 | −22 | 12 | −6 | 3 | −1 |
| 4/16 | −2 | 5 | −11 | 21 | −43 | 230 | 75 | −29 | 15 | −8 | 4 | −1 |
| 5/16 | −2 | 6 | −13 | 24 | −48 | 216 | 97 | −36 | 19 | −10 | 4 | −1 |
| 6/16 | −2 | 7 | −14 | 25 | −51 | 200 | 119 | −42 | 22 | −12 | 5 | −1 |
| 7/16 | −2 | 7 | −14 | 26 | −51 | 181 | 140 | −46 | 24 | −13 | 6 | −2 |
| 8/16 | −2 | 6 | −13 | 25 | −50 | 162 | 162 | −50 | 25 | −13 | 6 | −2 |
| 9/16 | −2 | 6 | −13 | 24 | −46 | 140 | 181 | −51 | 26 | −14 | 7 | −2 |
| 10/16 | −1 | 5 | −12 | 22 | −42 | 119 | 200 | −51 | 25 | −14 | 7 | −2 |
| 11/16 | −1 | 4 | −10 | 19 | −36 | 97 | 216 | −48 | 24 | −13 | 6 | −2 |
| 12/16 | −1 | 4 | −8 | 15 | −29 | 75 | 230 | −43 | 21 | −11 | 5 | −2 |
| 13/16 | −1 | 3 | −6 | 12 | −22 | 54 | 241 | −36 | 17 | −9 | 5 | −2 |
| 14/16 | 0 | 2 | −4 | 8 | −15 | 35 | 249 | −26 | 12 | −7 | 3 | −1 |
| 15/16 | 0 | 1 | −2 | 4 | −7 | 16 | 254 | −14 | 6 | −3 | 2 | −1 |

Template Matching Prediction JTMP)

Template matching (TM) prediction is a special merge mode based on Frame-Rate Up Conversion (FRUC) techniques. In one example TM mode, motion information of a block is not signalled, but derived at video decoder 300. TM may be applied to both AMVP mode and regular merge mode. In AMVP mode, MVP candidate selection is determined based on template matching to pick the candidate which reaches the minimal difference between current block template and reference block template. In regular merge mode, a TM mode flag is signalled to indicate the use of TM and then TM is applied to the merge candidate indicated by merge index for MV refinement.

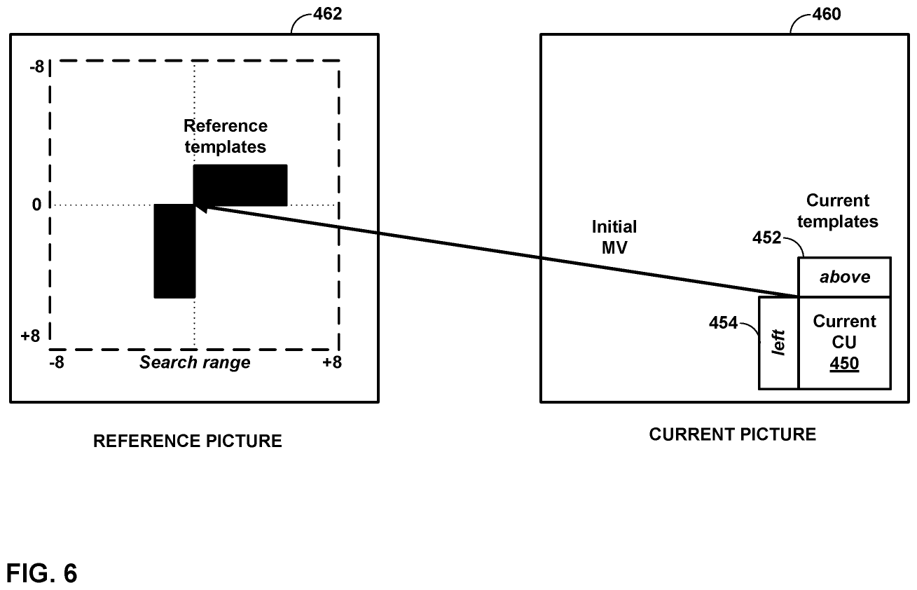

FIG. 6 is a conceptual diagram illustrating an example of template matching performed on a search area around an initial motion vector. As shown in FIG. 6, template matching is used to derive motion information of the current CU 450 by finding the closest match between an above template 452 and a left template 454 (above and/or left neighbouring blocks of the current CU 450) in current picture 460 and a block (the same size to the template) in reference picture 462. With an AMVP candidate selected based on initial matching error, its MVP is refined by template matching. With a merge candidate indicated by signaled merge index, its merged MVs corresponding to L0 and L1 are refined independently by template matching and then the less accurate candidate is further refined again with the better candidate as a prior.

Cost function: When a motion vector points to a fractional sample position, motion compensated interpolation is used. To reduce complexity, bi-linear interpolation, instead of 8-tap DCT-IF interpolation, may be used for template matching to generate templates on reference pictures. The matching cost C of template matching is calculated as follows:

C=SAD+w(|MVₓ−MVₓ^{s}|+|MV_{y}−MV_{y}^{s}|),

where w is a weighting factor which is empirically set to 4, MV and MV^{s} indicate the currently tested MV and the initial MV (e.g., a MVP candidate in AMVP mode or merged motion in merge mode), respectively. A sum of absolute differences (SAD) is used as the matching cost of template matching. In one example, when TM is used, motion is refined by using luma samples only. The derived motion will be used for both luma and chroma for motion compensated inter prediction. After the MV is determined, final motion compensation is performed using an 8-tap interpolation filter for luma and a 4-tap interpolation filter for chroma.

Search method: MV refinement is a pattern-based MV search with the criterion of template matching cost and a hierarchical structure. Two search patterns are supported—a diamond search and a cross search for MV refinement. The hierarchical structure specifies an iterative process to refine a MV, starting at a coarse MVD precision (e.g., quarter-pel) and ending at a fine precision (e.g., ⅛-pel). The MV is directly searched at quarter luma sample MVD precision with a diamond pattern, followed by quarter luma sample MVD precision with a cross pattern. This is followed by one-eighth luma sample MVD refinement with a cross pattern. The search range of MV refinement is set equal to (−8, +8) luma samples around the initial MV. When the current block is coded using bi-prediction, both MVs are refined independently, and then the best of which (in terms of matching cost) is set as a prior to further refine the other MV with BCW weight values.

MVD Sign Prediction

MVD sign prediction may be used to derive a certain cost given hypothetical MVDs and output the correct MVD sign predictor index by comparing the true MVD with an MVD candidate list sorted by cost. In this way, instead of directly signaling MVD signs in equal probability (EP) coding mode (e.g., bypass mode), the MVD sign predictor index which represents the correct MVD signs (e.g., the signs for the x and/or y component of the MVD) is coded with a context model. The conversion from EP coding to context-based coding is one source of the gain. Given one example to derive the cost based on current and reference templates, the decoder side MVD signs are derived by applying following steps:

1) Generate a list of MVD candidates based on absolute values of MVD components (four candidates if both X and Y components of the MVD are non-zero and two candidates if one component is zero);

2) Calculate a cost for each MVD candidate using template matching;

3) Rank the MVD candidates by sorting them based on calculated cost;

4) Determine an MVD and associated signs in the sorted list according to an MVD index obtained from bitstream (e.g., an MVD index into the sorted MVD candidate list, where the MVD index is signaled by the video encoder).

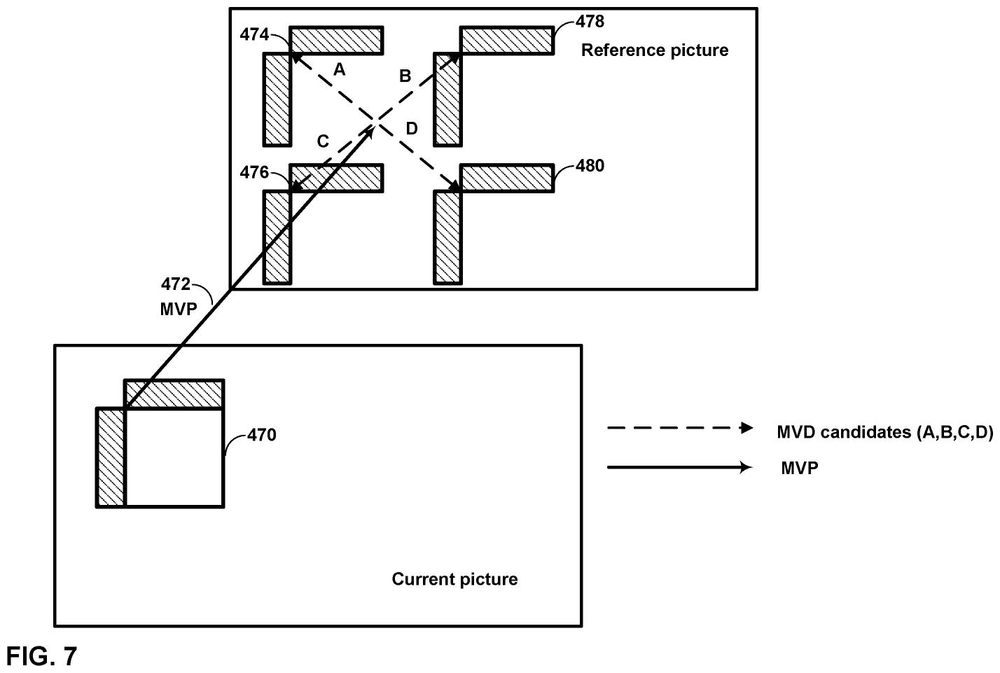

The template matching cost is measured using a certain metric between the template of the current CU and their corresponding reference template. An illustration of MVD sign prediction process using template matching is depicted in FIG. 7. MVD sign prediction could be applied to not only translational blocks, but also affine blocks.

In FIG. 7, a motion vector predictor (MVP) 472 of block 470 points to a particular location in a reference picture. Possible MVD candidates include MVD candidates A, B, C, and D. The MVD candidates include MVD magnitudes and signs. The four MVD candidates are offset from the location pointed to by MVP 472. Costs are determined for each of the four MVD candidates using above and left templates 474, 476, 478, and 480.

This disclosure describes techniques where MVD sign prediction is not only be applied to regular inter and affine inter mode, where the MVD is explicitly signalled, but also to MMVD mode and other modes where the MVD is determined from a step size indicating MVD magnitude and from direction indices. As described above, a direction index specifies the direction of the MVD which is equivalent to specifying the sign of a nonzero MVD component. This disclosure describes techniques where the direction index is not needed to be signed, but rather the MVD sign may be predicted using the MVD sign prediction techniques described below. With the introduction of new coding tools in ECM, MVD the sign prediction techniques of this disclosure can be further extended to several new coding tools like affine MMVD, GPM MMVD, and MHP, as discussed below.

MMVD Direction/Sign Prediction for MMVD

Video decoder 300 may decode an MMVD step index (e.g., indicating MVD magnitude information), and subsequently video decoder 300 may perform the MMVD direction (e.g., sign) prediction of this disclosure using the already decoded MVD magnitude information. As described above, video decoder 300 may be configured to determine the MVD magnitude information from an MMVD step index (e.g., the distance IDX of Table 1).

Depending on POC distances between the current picture and the two reference pictures, video decoder 300 may apply MVD scaling to the MVD magnitudes after the MVD magnitudes are derived using the step index. Note that while a single MVD magnitude may be derived, the derived MVD magnitude may be applied to each respective component of the MVD (e.g., the x component and the y component). As such, the MVD magnitude information described herein may be referred to as respective magnitudes of motion vector difference components.

Deriving the MVD sign is equivalent to deriving the direction index of a signalled MMVD direction index. Unlike regular inter mode and affine inter mode, where whether the x or y MVD component is non-zero is known, the MMVD direction index in MMVD mode specifies one zero component and one non-zero component. For example, an x component of the MVD is nonzero and a y component is zero, and vice versa. As such, which MVD component is nonzero as well as the associated sign remains unknown when performing MMVD direction prediction. Hence, MMVD direction prediction may be applied on both MVD components jointly, and an MMVD sign predictor index represents not only the sign information, but also determines which component is the non-zero component in the MVD.

Video decoder 300 determines the MMVD sign prediction by generating templates and deriving template matching costs using a MV that is derived by adding the MVP with all possible MVDs that contain different signs and non-zero locations. In MMVD, the MVP may be indicated by a merge index. With a current example MMVD design, a total number of four different MVDs can be used, and hence four different final MVs can be generated in a motion vector candidate list. As one example, from the decoded MMVD step index, video decoder 300 determines the MVD magnitude is 16. Video decoder constructs motion vector candidates using all the possible sign values (e.g., positive or negative for each MVD component as in Table 2 above). In this example, the motion vector candidates are (16, 0), (−16, 0), (0, 16), (0, −16).

In one example, the size of the templates of the current block used for cost determination are fixed with given block coordinates. However, the reference template location varies due to the existence of multiple possible final MVs (e.g., the list of motion vector candidates). With each of the MV candidates in the list, a corresponding reference template can be derived. Then, video decoder 300 may use a certain measure or metric to derive a cost when comparing the current template and reference template. In one example, video decoder 300 may calculate the cost as a sum of absolute differences (SAD). Other metrics like sum of square error (SSE) or any other power can also be used.

After the cost for each of the possible candidate motion vectors is derived, the candidate motion vectors are sorted based on the derived template matching cost. Video decoder 300 decodes an MMVD direction predictor index from the encoded video bitstream that indicates at which position within the sorted list is the true MVD located. In one example, The MMVD direction predictor index is signaled with context-coded bins. The true MVD with the correct sign and non-zero location can hence be derived to reconstruct the true final MV. Video decoder 300 determines the final MV by adding the MVD magnitude and determined sign to the previous determined MVP.

Accordingly, in view of the above, in one example of the disclosure, video decoder 300 may determine a the signs of the components of an MVD for MMVD mode using the following techniques. Video decoder 300 may construct motion vector candidates using possible sign values, respective magnitudes of motion vector difference components, and a motion vector predictor for a block of video data. The possible sign values include a positive sign value and a negative sign value for each of the possible components of the MVD (x component and y component), e.g., as shown in Table 2 above.

In one example, video decoder 300 may decode a merge index that indicates the motion vector predictor from a merge candidate list. Video decoder 300 may determine the respective magnitudes of motion vector difference components by decoding a step index (e.g., distance IDX in Table 1) above that indicates the respective magnitudes of the motion vector difference components.

Video decoder 300 may be further configured to sort the motion vector candidates based on a cost for each of the motion vector candidates to create a sorted list. Video decoder 300 may sort the list either by ascending or descending cost. As discussed above, video decoder 300 may use a SAD metric based on template matching to determine the cost for each of the candidates. Video decoder 300 may then determine a respective motion vector difference sign for each motion vector difference coordinate based on a motion vector sign predictor index and the sorted list. For example, video decoder 300 may decode a motion vector sign predictor index from the encoded video bitstream. The motion vector sign predictor index indicates a particular motion vector candidate in the sorted candidate list. Video decoder 300 may determine the sign values for the MVD magnitudes to use in determining a final motion vector from the sign values of the motion vector candidate in the sorted list that corresponds to the motion vector sign predictor index.

Video decoder 300 may then decode the block of video data using the respective magnitudes of motion vector difference coordinates and the respective motion vector difference sign for each motion vector difference component. For example, video decoder 300 may apply the respective motion vector difference sign for each motion vector difference components to the respective magnitudes of the motion vector difference components to determine a motion vector difference, add the motion vector difference to the motion vector predictor to determine a final motion vector, and decode the block of video data using the final motion vector. In this manner, the signs for the magnitudes of MVD components may be determined with less signaling overhead, thus increasing coding efficiency.

MMVD Direction/Sign Prediction for Affine MMVD

Similar to the MMVD sing/direction prediction procedure as described above, a MMVD sign predictor index for affine MMVD can also be derived in a similar manner. However, there are several differences due to the characteristic of affine inter prediction mode.

First, the MVDs for different CPMVs remain the same, and hence the same MVD is added to each of the CPMV to derive the final CPMV.

Secondly, CPMVs are not directly used to generate a reference template. A motion vector field is generated based on an affine motion model for each of the 4×4 sub-block.

Finally, the template of both the current block and the reference block are generated based on the motion vector of each of the sub-block and the template matching cost is aggregated over each of the sub-block for the final template matching cost.

With the template matching cost derived, the MMVD direction predictor index is again used in the same way as in MMVD to derive the true MVD.

MMVD Sign/Direction Prediction for GPM MMVD

MMVD sign/direction prediction can also be extended to GPM MMVD. Due to the characteristics of GPM MMVD, some changes may be implemented compared to the MVD sign prediction design used in MMVD described above.

Unlike MMVD and affine MMVD, where in case of bi-prediction, one MVD is equal to, opposite to, or a scaled version of the other MVD, there is no correlation between the two MVDs for the two GPM partitions in GPM MMVD mode. Due to this fact, up to two MMVD sign predictor indices may need to be signalled and the derivation of the MMVD sign predictor is done separately for each of the GPM partition.

What's more, the number of possible MVD sign combinations is also increased from 4 to 8 due to the additional introduction of the diagonal and anti-diagonal directions.

MVD Sign Prediction for MHP

The final predictor of MHP includes a base and up to two additional hypotheses. For MHP, the base may be any one of the modes among inter mode, affine mode, merge mode, affine merge mode, inter MMVD mode, and affine MMVD mode. The additional hypothesis may be either of unidirectional inter mode or of unidirectional merge mode.

Thus, MVD sign prediction is applicable to MHP on both the MHP base and the additional hypothesis. When the base is inter mode, affine mode, inter MMVD mode or affine MMVD mode, MVD sign prediction can be applied on the MHP base. When the additional hypothesis is selected to be inter prediction mode, MVD sign prediction can also be applied. The MVD sign predictor indices for MHP base and hypothesis are generated separately.

Even though MVD sign prediction can be applied to both MHP base and hypothesis, in some examples, MVD sign prediction is only allowed to be used for MHP base. In another example, MVD sign prediction is only applied to the additional hypothesis.

MVD Sign Prediction Template Generation

In MVD sign prediction, the template can be selected differently. First, the template shape can have different variations. In one example, both the above template and the left template are used and the template is of L-shape. In another example, only the above template is used. In a third example, only the left template is used.

Secondly, the template can be generated using different interpolation filters. In template matching TM merge mode, the template is generated using a bilinear interpolation filter. For a template in MVD sign prediction, the same bilinear filter can be used in template generation. In another example, a 12-tap interpolation filter can be used to generate the template.

Thirdly, the template size can be chosen differently. Usually, the template size for inter mode is selected to be 4 rows and 4 columns; and the template size for affine mode is selected to be 1 row and 1 column. However, the template size can be changed. For example, the template size for affine mode can be increased to be the same as inter mode. In another example, the template may be sub-sampled with a given factor to reduce the computation complexity.

MVD Sign Prediction Cost Derivation

In MVD sign prediction, besides template matching cost, other costs can be used. In one example, instead of using the template, the reconstructed blocks might be generated by adding the reconstructed residual signal, which may be signaled in the form of quantized transform coefficients, to the predictors. Video decoder 300 may then derive a cost between the current reconstructed block and the reference block. In another example, the gradient values around the current block boundary can be used to derive the cost in MVD sign prediction.

When deriving the cost, different norms can be used. Usually, the sum of absolute differences (SAD) which is the L1 norm, or the sum of square error (SSD), which is the L2 norm, can be used. However, in principle, other Ln norms and any other known norm can be used.

For translational inter SMVD (symmetrical MVD) mode, inter MMVD, and affine MMVD mode, bi-directional prediction can be selected. On top of that, only the MVD for one reference list needs to be signaled and the MVD for the other list can be derived from the first list. In this case, when deriving the MVD sign prediction cost, either reference blocks/templates from a single list or from both reference lists can be used in MVD sign prediction process.

In one example, only the reference blocks/templates from reference list 0 are used to derive the cost. In a second example, only the reference blocks/templates from reference list 1 are used to derive the cost. In a third example, reference blocks/templates from both reference list 0 and list 1 are used to derive the cost. In another example, one reference list may derive the template matching cost based on a current block's template and a reference template, while the second part of the cost is derived from the bilateral matching cost between reference blocks from reference list 0 and list 1.

MVD Sign Prediction Threshold

MVD sign prediction might be conditionally applied on certain blocks when a certain threshold is met. To make the MVD sign prediction stable, it may be beneficial that the block size is large enough to include an adequate number of samples for cost derivation. Moreover, it is preferable that the MVD magnitude is large enough so that all the possible final MVs can be distributed sparsely to include different image areas in the cost derivation. Hence, in one example, a block size based threshold (usually defined by the number of samples within the block) is applied and only blocks with block size that is larger than (or equal to) the threshold can use MVD sign prediction. In another example, the MVD magnitude threshold is used to decide if MVD sign prediction can be applied on a block. In another example, the combination of both thresholds can be applied.

Alternatively, separate contexts may be applied for the context-coded MVD sign bins or MMVD direction prediction index depending on the MVD magnitude. Here it is assumed that MVD magnitude is known before parsing MVD sign bins or MMVD direction prediction index.

### General Example

The MVD sign prediction process can be described as follows:
1. Parse the magnitude of MVD components.
2. Parse context-coded MVD sign predictor index.
3. Build MV candidates by creating combination between possible signs and absolute MVD value and add it to the MV predictor.
4. Derive MVD sign prediction cost for each derived MV based on some metric and sort.
5. Use corresponding MVD sign predictor index to pick the true MVD sign
6. Add the true MVD to the MV predictor for final MV.
   All the examples mentioned in the sections above can be applied to all the inter prediction mode where MVD sign prediction is applicable. These modes include those that are elaborated in this document: inter MMVD, affine MMVD, GPM MMVD and MHP. Additionally, MVD sign prediction can also be applied to translational inter mode, SMVD mode and affine inter mode.

Accordingly, in one example of the disclosure, video decoder 300 may be configured to decode magnitudes of motion vector difference coordinates for a block of video data, decoded a motion vector sign predictor index, construct motion vector candidates using possible sign values and the magnitudes of the motion vector difference coordinates, derive a motion vector difference sign prediction cost for each of the motion vector candidates, sort the motion vector candidates based on the cost for each of the motion vector candidates to create a sorted list, determine the motion vector difference sign based on the motion vector sign predictor index and the sorted list, and decode the block of video data using the magnitudes of motion vector difference coordinates and the motion vector difference sign.

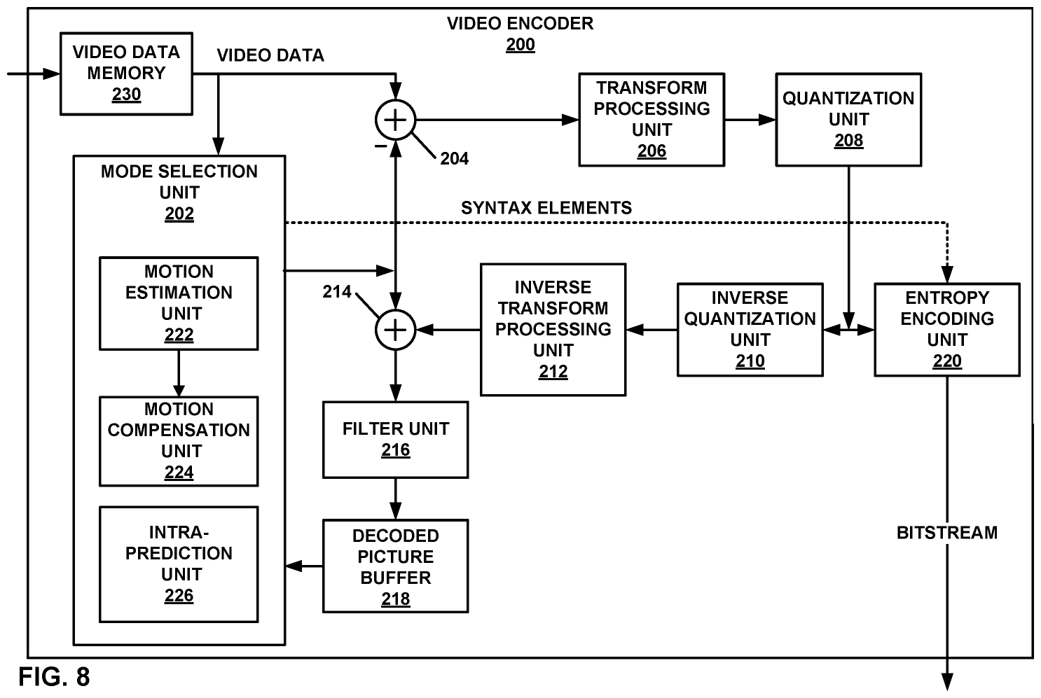

FIG. 8 is a block diagram illustrating an example video encoder 200 that may perform the techniques of this disclosure. FIG. 8 is provided for purposes of explanation and should not be considered limiting of the techniques as broadly exemplified and described in this disclosure. For purposes of explanation, this disclosure describes video encoder 200 according to the techniques of VVC (ITU-T H.266, under development), and HEVC (ITU-T H.265). However, the techniques of this disclosure may be performed by video encoding devices that are configured to other video coding standards and video coding formats, such as AV1 and successors to the AV1 video coding format.

In the example of FIG. 8, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. For instance, the units of video encoder 200 may be implemented as one or more circuits or logic elements as part of hardware circuitry, or as part of a processor, ASIC, or FPGA. Moreover, video encoder 200 may include additional or alternative processors or processing circuitry to perform these and other functions.

Video data memory 230 may store video data to be encoded by the components of video encoder 200. Video encoder 200 may receive the video data stored in video data memory 230 from, for example, video source 104 (FIG. 1). DPB 218 may act as a reference picture memory that stores reference video data for use in prediction of subsequent video data by video encoder 200. Video data memory 230 and DPB 218 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 8 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, a motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUs, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the MTT structure, QTBT structure. superblock structure, or the quad-tree structure described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

When operating according to the AV1 video coding format, motion estimation unit 222 and motion compensation unit 224 may be configured to encode coding blocks of video data (e.g., both luma and chroma coding blocks) using translational motion compensation, affine motion compensation, overlapped block motion compensation (OBMC), and/or compound inter-intra prediction.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

When operating according to the AV1 video coding format, intra prediction unit 226 may be configured to encode coding blocks of video data (e.g., both luma and chroma coding blocks) using directional intra prediction, non-directional intra prediction, recursive filter intra prediction, chroma-from-luma (CFL) prediction, intra block copy (IBC), and/or color palette mode. Mode selection unit 202 may include additional functional units to perform video prediction in accordance with other prediction modes.

Mode selection unit 202 provides the prediction block to residual generation unit 204. Residual generation unit 204 receives a raw, unencoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU.

Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as some examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

When operating according to AV1, transform processing unit 206 may apply one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a horizontal/vertical transform combination that may include a discrete cosine transform (DCT), an asymmetric discrete sine transform (ADST), a flipped ADST (e.g., an ADST in reverse order), and an identity transform (IDTX). When using an identity transform, the transform is skipped in one of the vertical or horizontal directions. In some examples, transform processing may be skipped.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

When operating according to AV1, filter unit 216 may perform one or more filter operations on reconstructed blocks. For example, filter unit 216 may perform deblocking operations to reduce blockiness artifacts along edges of CUs. In other examples, filter unit 216 may apply a constrained directional enhancement filter (CDEF), which may be applied after deblocking, and may include the application of non-separable, non-linear, low-pass directional filters based on estimated edge directions. Filter unit 216 may also include a loop restoration filter, which is applied after CDEF, and may include a separable symmetric normalized Wiener filter or a dual self-guided filter.

Video encoder 200 stores reconstructed blocks in DPB 218. For instance, in examples where operations of filter unit 216 are not performed, reconstruction unit 214 may store reconstructed blocks to DPB 218. In examples where operations of filter unit 216 are performed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

In accordance with AV1, entropy encoding unit 220 may be configured as a symbol-to-symbol adaptive multi-symbol arithmetic coder. A syntax element in AV1 includes an alphabet of N elements, and a context (e.g., probability model) includes a set of N probabilities. Entropy encoding unit 220 may store the probabilities as n-bit (e.g., 15-bit) cumulative distribution functions (CDFs). Entropy encoding unit 22 may perform recursive scaling, with an update factor based on the alphabet size, to update the contexts.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

Video encoder 200 represents an example of a device configured to encode video data including a memory configured to store video data, and one or more processing units implemented in circuitry and configured to perform one or more techniques of the disclosure described above for MVD sign prediction.

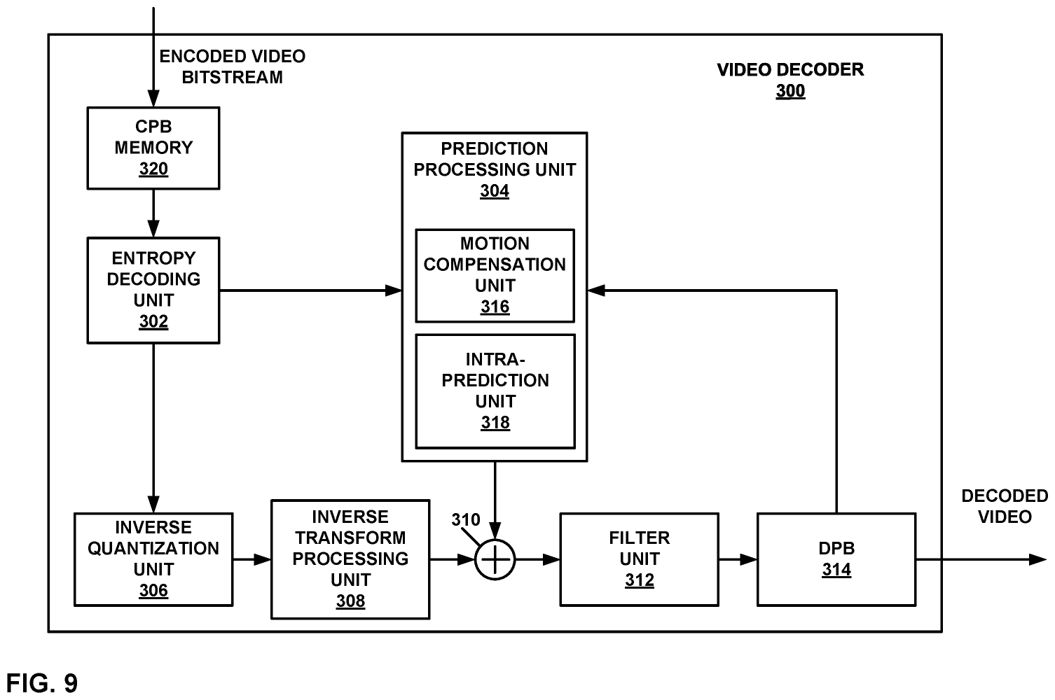

FIG. 9 is a block diagram illustrating an example video decoder 300 that may perform the techniques of this disclosure. FIG. 9 is provided for purposes of explanation and is not limiting on the techniques as broadly exemplified and described in this disclosure. For purposes of explanation, this disclosure describes video decoder 300 according to the techniques of VVC (ITU-T H.266, under development), and HEVC (ITU-T H.265). However, the techniques of this disclosure may be performed by video coding devices that are configured to other video coding standards.

In the example of FIG. 9, video decoder 300 includes coded picture buffer (CPB) memory 320, entropy decoding unit 302, prediction processing unit 304, inverse quantization unit 306, inverse transform processing unit 308, reconstruction unit 310, filter unit 312, and decoded picture buffer (DPB) 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. For instance, the units of video decoder 300 may be implemented as one or more circuits or logic elements as part of hardware circuitry, or as part of a processor, ASIC, or FPGA. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

When operating according to AV1, compensation unit 316 may be configured to decode coding blocks of video data (e.g., both luma and chroma coding blocks) using translational motion compensation, affine motion compensation, OBMC, and/or compound inter-intra prediction, as described above. Intra prediction unit 318 may be configured to decode coding blocks of video data (e.g., both luma and chroma coding blocks) using directional intra prediction, non-directional intra prediction, recursive filter intra prediction, CFL, intra block copy (IBC), and/or color palette mode, as described above.

CPB memory 320 may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 generally stores decoded pictures, which video decoder 300 may output and/or use as reference video data when decoding subsequent data or pictures of the encoded video bitstream. CPB memory 320 and DPB 314 may be formed by any of a variety of memory devices, such as DRAM, including SDRAM, MRAM, RRAM, or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 9 are illustrated to assist with understanding the operations performed by video decoder 300. The units may be implemented as fixed-function circuits, programmable circuits, or a combination thereof. Similar to FIG. 8, fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 8).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 8). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

In this manner, video decoder 300 represents an example of a video decoding device including a memory configured to store video data, and one or more processing units implemented in circuitry and configured to construct motion vector candidates using possible sign values, respective magnitudes of motion vector difference components, and a motion vector predictor for a block of video data, wherein the possible sign values include a positive sign value and a negative sign value, sort the motion vector candidates based on a cost for each of the motion vector candidates to create a sorted list, determine a respective motion vector difference sign for each motion vector difference coordinate based on a motion vector sign predictor index and the sorted list, and decode the block of video data using the respective magnitudes of motion vector difference coordinates and the respective motion vector difference sign for each motion vector difference component.

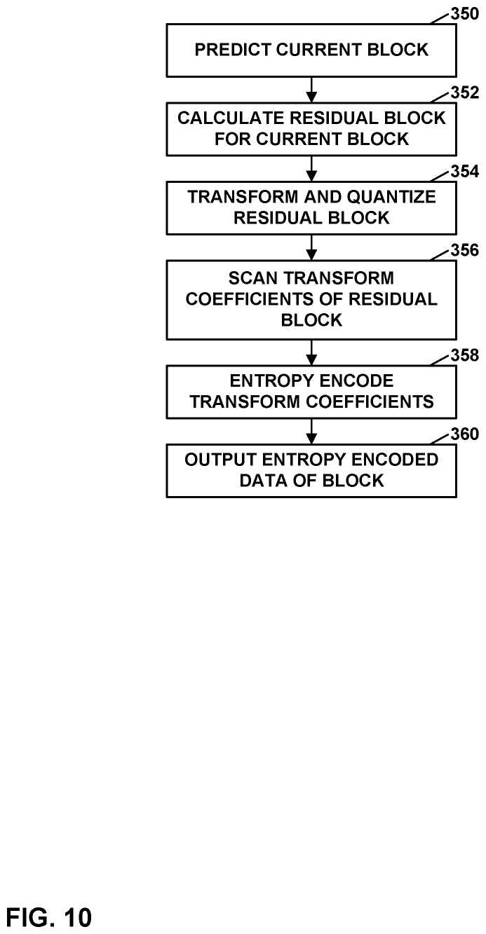

FIG. 10 is a flowchart illustrating an example method for encoding a current block in accordance with the techniques of this disclosure. The current block may comprise a current CU. Although described with respect to video encoder 200 (FIGS. 1 and 8), it should be understood that other devices may be configured to perform a method similar to that of FIG. 10.

In this example, video encoder 200 initially predicts the current block (350). For example, video encoder 200 may form a prediction block for the current block. Video encoder 200 may then calculate a residual block for the current block (352). To calculate the residual block, video encoder 200 may calculate a difference between the original, unencoded block and the prediction block for the current block. Video encoder 200 may then transform the residual block and quantize transform coefficients of the residual block (354). Next, video encoder 200 may scan the quantized transform coefficients of the residual block (356). During the scan, or following the scan, video encoder 200 may entropy encode the transform coefficients (358). For example, video encoder 200 may encode the transform coefficients using CAVLC or CABAC. Video encoder 200 may then output the entropy encoded data of the block (360).

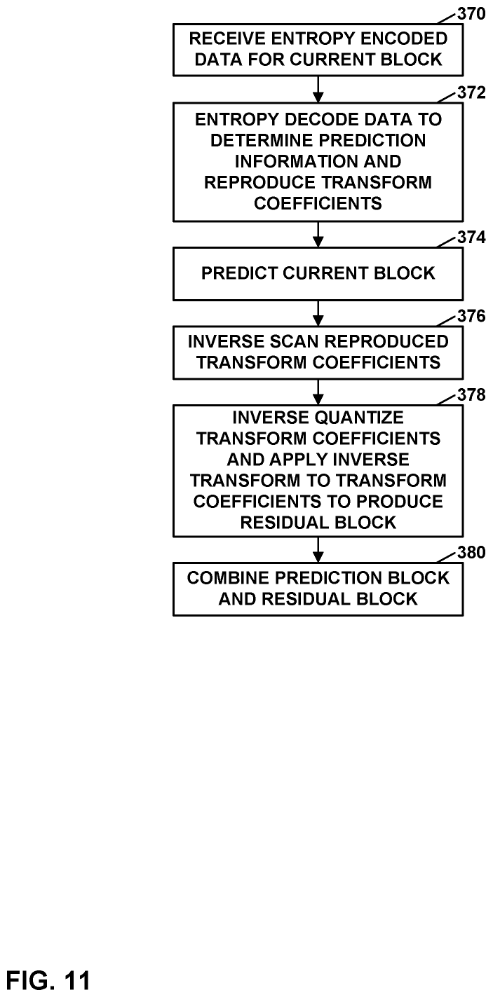

FIG. 11 is a flowchart illustrating an example method for decoding a current block of video data in accordance with the techniques of this disclosure. The current block may comprise a current CU. Although described with respect to video decoder 300 (FIGS. 1 and 9), it should be understood that other devices may be configured to perform a method similar to that of FIG. 11.

Video decoder 300 may receive entropy encoded data for the current block, such as entropy encoded prediction information and entropy encoded data for transform coefficients of a residual block corresponding to the current block (370). Video decoder 300 may entropy decode the entropy encoded data to determine prediction information for the current block and to reproduce transform coefficients of the residual block (372). Video decoder 300 may predict the current block (374), e.g., using an intra- or inter-prediction mode as indicated by the prediction information for the current block, to calculate a prediction block for the current block. Video decoder 300 may then inverse scan the reproduced transform coefficients (376), to create a block of quantized transform coefficients. Video decoder 300 may then inverse quantize the transform coefficients and apply an inverse transform to the transform coefficients to produce a residual block (378). Video decoder 300 may ultimately decode the current block by combining the prediction block and the residual block (380).

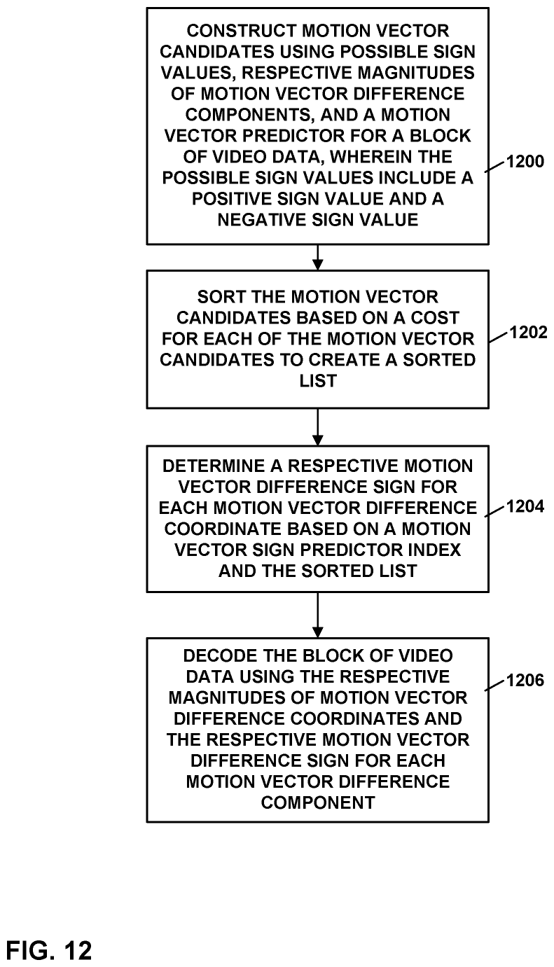

FIG. 12 is a flowchart illustrating another example method for decoding a current block in accordance with the techniques of this disclosure. The techniques of FIG. 12 may be performed by one or more structural components of video decoder 300, including motion compensation unit 316.

In one example of the disclosure, video decoder 300 may be configured to construct motion vector candidates using possible sign values, respective magnitudes of motion vector difference components, and a motion vector predictor for a block of video data, wherein the possible sign values include a positive sign value and a negative sign value (1200). Video decoder 300 may be further configured to sort the motion vector candidates based on a cost for each of the motion vector candidates to create a sorted list (1202). Video decoder 300 may further determine a respective motion vector difference sign for each motion vector difference coordinate based on a motion vector sign predictor index and the sorted list (1204), decode the block of video data using the respective magnitudes of motion vector difference coordinates and the respective motion vector difference sign for each motion vector difference component (1206).

In the example above, the block of video data may be coded using one of inter merge with motion vector difference (MMVD) mode, affine MMVD, geometric partitioning mode (GPM) with MMVD, or multi-hypothesis prediction (MHP) mode.

In a specific example, the block of video data is coded using inter MMVD mode. In this example, video decoder 300 may be further configured to decode a merge index that indicates the motion vector predictor, decode a step index that indicates the respective magnitudes of motion vector difference coordinates, and decode the motion vector sign predictor index. Video decoder 300 may be further configured to apply the respective motion vector difference sign for each motion vector difference components to the respective magnitudes of the motion vector difference components to determine a motion vector difference, add the motion vector difference to the motion vector predictor to determine a final motion vector, and decode the block of video data using the final motion vector.

In another specific example, the block of video data is coded using affine MMVD mode and the motion vector predictor includes two or three control point motion vectors. In this example video decoder 300 may be configured to determine the control point motion vectors, decode a step index that indicates the respective magnitudes of motion vector difference coordinates, and decode the motion vector sign predictor index. Video decoder 300 may be further configured to apply the respective motion vector difference sign for each motion vector difference components to the respective magnitudes of the motion vector difference components to determine a motion vector difference, add the motion vector difference to each of the control point motion vectors to determine final control point motion vectors, and decode the block of video data using the final control point motion vectors.

In any of the above examples, video decoder 300 may be further configured to determine the cost using template matching. As one example, when the block of video data is coded using affine MMVD merge with motion vector difference (MMVD) mode, video decoder 300 may be configured to determine the cost using sub-block based template matching. Furthermore, in any of the above examples, video decoder 300 may be further configured to scale the respective magnitudes of motion vector difference components based on a picture order count (POC) difference.

Additional aspects of the disclosure are described below.

Aspect 1A—A method of coding video data, the method comprising: decoding magnitudes of motion vector difference coordinates for a block of video data; decoding a motion vector sign predictor index; constructing motion vector candidates using possible sign values and the magnitudes of the motion vector difference coordinates; deriving a motion vector difference sign prediction cost for each of the motion vector candidates; sorting the motion vector candidates based on the cost for each of the motion vector candidates to create a sorted list; determining the motion vector difference sign based on the motion vector sign predictor index and the sorted list; and decoding the block of video data using the magnitudes of motion vector difference coordinates and the motion vector difference sign.

Aspect 2A—The method of Aspect 1A, wherein the block of video data is coded using one of inter merge with motion vector difference (MMVD) mode, affine MMVD, geometric partitioning mode (GPM) with MMVD, and multi-hypothesis prediction (MHP) mode.

Aspect 3A—A device for coding video data, the device comprising one or more means for performing the method of any of Aspects 1A-2A.

Aspect 4A—The device of Aspect 3A, wherein the one or more means comprise one or more processors implemented in circuitry.

Aspect 5A—The device of any of Aspects 3A and 4A, further comprising a memory to store the video data.

Aspect 6A—The device of any of Aspects 3A-5A, further comprising a display configured to display decoded video data.

Aspect 7A—The device of any of Aspects 3A-6A, wherein the device comprises one or more of a camera, a computer, a mobile device, a broadcast receiver device, or a set-top box.

Aspect 8A—The device of any of Aspects 3A-7A, wherein the device comprises a video decoder.

Aspect 9A—The device of any of Aspects 3A-8A, wherein the device comprises a video encoder.

Aspect 10A—A computer-readable storage medium having stored thereon instructions that, when executed, cause one or more processors to perform the method of any of Aspects 1A-2A.

Aspect 11A—A device for decoding video data, the device comprising: means for decoding magnitudes of motion vector difference coordinates for a block of video data; means for decoding a motion vector sign predictor index; means for constructing motion vector candidates using possible sign values and the magnitudes of the motion vector difference coordinates; means for deriving a motion vector difference sign prediction cost for each of the motion vector candidates; means for sorting the motion vector candidates based on the cost for each of the motion vector candidates to create a sorted list; means for determining the motion vector difference sign based on the motion vector sign predictor index and the sorted list; and means for decoding the block of video data using the magnitudes of motion vector difference coordinates and the motion vector difference sign.

Aspect 1B—A method of decoding video data, the method comprising: constructing motion vector candidates using possible sign values, respective magnitudes of motion vector difference components, and a motion vector predictor for a block of video data, wherein the possible sign values include a positive sign value and a negative sign value; sorting the motion vector candidates based on a cost for each of the motion vector candidates to create a sorted list; determining a respective motion vector difference sign for each motion vector difference coordinate based on a motion vector sign predictor index and the sorted list; and decoding the block of video data using the respective magnitudes of motion vector difference coordinates and the respective motion vector difference sign for each motion vector difference component.

Aspect 2B—The method of Aspect 1B, wherein the block of video data is coded using one of inter merge with motion vector difference (MMVD) mode, affine MMVD, geometric partitioning mode (GPM) with MMVD, or multi-hypothesis prediction (MHP) mode.

Aspect 3B—The method of Aspect 2B, wherein the block of video data is coded using inter MMVD mode, the method further comprising: decoding a merge index that indicates the motion vector predictor; decoding a step index that indicates the respective magnitudes of motion vector difference coordinates; and decoding the motion vector sign predictor index.

Aspect 4B—The method of Aspect 3B, further comprising: applying the respective motion vector difference sign for each motion vector difference components to the respective magnitudes of the motion vector difference components to determine a motion vector difference; adding the motion vector difference to the motion vector predictor to determine a final motion vector; and decoding the block of video data using the final motion vector.

Aspect 5B—The method of Aspect 2B, wherein the block of video data is coded using affine MMVD mode, and the motion vector predictor includes two or three control point motion vectors, the method further comprising: determining the control point motion vectors; decoding a step index that indicates the respective magnitudes of motion vector difference coordinates; and decoding the motion vector sign predictor index.

Aspect 6B—The method of Aspect 5B, the method further comprising: applying the respective motion vector difference sign for each motion vector difference components to the respective magnitudes of the motion vector difference components to determine a motion vector difference; adding the motion vector difference to each of the control point motion vectors to determine final control point motion vectors; and decoding the block of video data using the final control point motion vectors.

Aspect 7B—The method of Aspect 1B, further comprising: determining the cost using template matching.

Aspect 8B—The method of Aspect 7B, wherein the block of video data is coded using affine MMVD merge with motion vector difference (MMVD) mode, and wherein determining the cost using template matching comprises: determining the cost using sub-block based template matching.

Aspect 9B—The method of Aspect 1B, further comprising: scaling the respective magnitudes of motion vector difference components based on a picture order count (POC) difference.

Aspect 10B—The method of Aspect 1B, further comprising: displaying a picture that includes the decoded block of video data.

Aspect 11B—An apparatus configured to decode video data, the apparatus comprising: a memory configured to store a block of video data; and one or more processors in communication with the memory, the one or more processors configured to: construct motion vector candidates using possible sign values, respective magnitudes of motion vector difference components, and a motion vector predictor for a block of video data, wherein the possible sign values include a positive sign value and a negative sign value; sort the motion vector candidates based on a cost for each of the motion vector candidates to create a sorted list; determine a respective motion vector difference sign for each motion vector difference coordinate based on a motion vector sign predictor index and the sorted list; and decode the block of video data using the respective magnitudes of motion vector difference coordinates and the respective motion vector difference sign for each motion vector difference component.

Aspect 12B—The apparatus of Aspect 11B, wherein the block of video data is coded using one of inter merge with motion vector difference (MMVD) mode, affine MMVD, geometric partitioning mode (GPM) with MMVD, or multi-hypothesis prediction (MHP) mode.

Aspect 13B—The apparatus of Aspect 12B, wherein the block of video data is coded using inter MMVD mode, and wherein the one or more processors are further configured to: decode a merge index that indicates the motion vector predictor; decode a step index that indicates the respective magnitudes of motion vector difference coordinates; and decode the motion vector sign predictor index.

Aspect 14B—The apparatus of Aspect 13B, wherein the one or more processors are further configured to: apply the respective motion vector difference sign for each motion vector difference components to the respective magnitudes of the motion vector difference components to determine a motion vector difference; add the motion vector difference to the motion vector predictor to determine a final motion vector; and decode the block of video data using the final motion vector.

Aspect 15B—The apparatus of Aspect 12B, wherein the block of video data is coded using affine MMVD mode, the motion vector predictor includes two or three control point motion vectors, and wherein the one or more processors are further configured to: determine the control point motion vectors; decode a step index that indicates the respective magnitudes of motion vector difference coordinates; and decode the motion vector sign predictor index.

Aspect 16B—The apparatus of Aspect 15B, wherein the one or more processors are further configured to: apply the respective motion vector difference sign for each motion vector difference components to the respective magnitudes of the motion vector difference components to determine a motion vector difference; add the motion vector difference to each of the control point motion vectors to determine final control point motion vectors; and decode the block of video data using the final control point motion vectors.

Aspect 17B—The apparatus of Aspect 11B, wherein the one or more processors are further configured to: determine the cost using template matching.

Aspect 18B—The apparatus of Aspect 17B, wherein the block of video data is coded using affine MMVD merge with motion vector difference (MMVD) mode, and wherein to determine the cost using template matching, the one or more processors are further configured to: determine the cost using sub-block based template matching.

Aspect 19B—The apparatus of Aspect 11B, wherein the one or more processors are further configured to: scale the respective magnitudes of motion vector difference components based on a picture order count (POC) difference.

Aspect 20B—The apparatus of Aspect 11B, further comprising: a display configured to display a picture that includes the decoded block of video data.

Aspect 1C—A method of decoding video data, the method comprising: constructing motion vector candidates using possible sign values, respective magnitudes of motion vector difference components, and a motion vector predictor for a block of video data, wherein the possible sign values include a positive sign value and a negative sign value; sorting the motion vector candidates based on a cost for each of the motion vector candidates to create a sorted list; determining a respective motion vector difference sign for each motion vector difference coordinate based on a motion vector sign predictor index and the sorted list; and decoding the block of video data using the respective magnitudes of motion vector difference coordinates and the respective motion vector difference sign for each motion vector difference component.

Aspect 2C—The method of Aspect 1C, wherein the block of video data is coded using one of inter merge with motion vector difference (MMVD) mode, affine MMVD, geometric partitioning mode (GPM) with MMVD, or multi-hypothesis prediction (MHP) mode.

Aspect 3C—The method of Aspect 2C, wherein the block of video data is coded using inter MMVD mode, the method further comprising: decoding a merge index that indicates the motion vector predictor; decoding a step index that indicates the respective magnitudes of motion vector difference coordinates; and decoding the motion vector sign predictor index.

Aspect 4C—The method of Aspect 3C, further comprising: applying the respective motion vector difference sign for each motion vector difference components to the respective magnitudes of the motion vector difference components to determine a motion vector difference; adding the motion vector difference to the motion vector predictor to determine a final motion vector; and decoding the block of video data using the final motion vector.

Aspect 5C—The method of Aspect 2C, wherein the block of video data is coded using affine MMVD mode, and the motion vector predictor includes two or three control point motion vectors, the method further comprising: determining the control point motion vectors; decoding a step index that indicates the respective magnitudes of motion vector difference coordinates; and decoding the motion vector sign predictor index.

Aspect 6C—The method of Aspect 5C, the method further comprising: applying the respective motion vector difference sign for each motion vector difference components to the respective magnitudes of the motion vector difference components to determine a motion vector difference; adding the motion vector difference to each of the control point motion vectors to determine final control point motion vectors; and decoding the block of video data using the final control point motion vectors.

Aspect 7C—The method of any of Aspects 1C-6C, further comprising: determining the cost using template matching.

Aspect 8C—The method of Aspect 7C, wherein the block of video data is coded using affine MMVD merge with motion vector difference (MMVD) mode, and wherein determining the cost using template matching comprises: determining the cost using sub-block based template matching.

Aspect 9C—The method of any of Aspects 1C-8C, further comprising: scaling the respective magnitudes of motion vector difference components based on a picture order count (POC) difference.

Aspect 10C—The method of any of Aspects 1C-9C, further comprising: displaying a picture that includes the decoded block of video data.

Aspect 11C—An apparatus configured to decode video data, the apparatus comprising: a memory configured to store a block of video data; and one or more processors in communication with the memory, the one or more processors configured to: construct motion vector candidates using possible sign values, respective magnitudes of motion vector difference components, and a motion vector predictor for a block of video data, wherein the possible sign values include a positive sign value and a negative sign value; sort the motion vector candidates based on a cost for each of the motion vector candidates to create a sorted list; determine a respective motion vector difference sign for each motion vector difference coordinate based on a motion vector sign predictor index and the sorted list; and decode the block of video data using the respective magnitudes of motion vector difference coordinates and the respective motion vector difference sign for each motion vector difference component.

Aspect 12C—The apparatus of Aspect 11C, wherein the block of video data is coded using one of inter merge with motion vector difference (MMVD) mode, affine MMVD, geometric partitioning mode (GPM) with MMVD, or multi-hypothesis prediction (MHP) mode.

Aspect 13C—The apparatus of Aspect 12C, wherein the block of video data is coded using inter MMVD mode, and wherein the one or more processors are further configured to: decode a merge index that indicates the motion vector predictor; decode a step index that indicates the respective magnitudes of motion vector difference coordinates; and decode the motion vector sign predictor index.

Aspect 14C—The apparatus of Aspect 13C, wherein the one or more processors are further configured to: apply the respective motion vector difference sign for each motion vector difference components to the respective magnitudes of the motion vector difference components to determine a motion vector difference; add the motion vector difference to the motion vector predictor to determine a final motion vector; and decode the block of video data using the final motion vector.

Aspect 15C—The apparatus of Aspect 12C, wherein the block of video data is coded using affine MMVD mode, the motion vector predictor includes two or three control point motion vectors, and wherein the one or more processors are further configured to: determine the control point motion vectors; decode a step index that indicates the respective magnitudes of motion vector difference coordinates; and decode the motion vector sign predictor index.

Aspect 16C—The apparatus of Aspect 15C, wherein the one or more processors are further configured to: apply the respective motion vector difference sign for each motion vector difference components to the respective magnitudes of the motion vector difference components to determine a motion vector difference; add the motion vector difference to each of the control point motion vectors to determine final control point motion vectors; and decode the block of video data using the final control point motion vectors.

Aspect 17C—The apparatus of any of Aspects 11C-16C, wherein the one or more processors are further configured to: determine the cost using template matching.

Aspect 18C—The apparatus of Aspect 17C, wherein the block of video data is coded using affine MMVD merge with motion vector difference (MMVD) mode, and wherein to determine the cost using template matching, the one or more processors are further configured to: determine the cost using sub-block based template matching.

Aspect 19C—The apparatus of any of Aspects 11C-18C, wherein the one or more processors are further configured to: scale the respective magnitudes of motion vector difference components based on a picture order count (POC) difference.

Aspect 20C—The apparatus of any of Aspects 11C-19C, further comprising: a display configured to display a picture that includes the decoded block of video data.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding video data, the method comprising:
constructing motion vector candidates using possible sign values, respective magnitudes of motion vector difference components, and a motion vector predictor for a block of video data, wherein the possible sign values include a positive sign value and a negative sign value;
sorting the motion vector candidates based on a cost for each of the motion vector candidates to create a sorted list;
determining a respective motion vector difference sign for each motion vector difference coordinate based on a motion vector sign predictor index and the sorted list; and
decoding the block of video data using the respective magnitudes of motion vector difference coordinates and the respective motion vector difference sign for each motion vector difference component.

2. The method of claim 1, wherein the block of video data is coded using one of inter merge with motion vector difference (MMVD) mode, affine MMVD, geometric partitioning mode (GPM) with MMVD, or multi-hypothesis prediction (MHP) mode.

3. The method of claim 2, wherein the block of video data is coded using inter MMVD mode, the method further comprising:
decoding a merge index that indicates the motion vector predictor;
decoding a step index that indicates the respective magnitudes of motion vector difference coordinates; and
decoding the motion vector sign predictor index.

4. The method of claim 3, further comprising:
applying the respective motion vector difference sign for each motion vector difference components to the respective magnitudes of the motion vector difference components to determine a motion vector difference;
adding the motion vector difference to the motion vector predictor to determine a final motion vector; and
decoding the block of video data using the final motion vector.

5. The method of claim 2, wherein the block of video data is coded using affine MMVD mode, and the motion vector predictor includes two or three control point motion vectors, the method further comprising:
determining the control point motion vectors;
decoding a step index that indicates the respective magnitudes of motion vector difference coordinates; and
decoding the motion vector sign predictor index.

6. The method of claim 5, the method further comprising:
applying the respective motion vector difference sign for each motion vector difference components to the respective magnitudes of the motion vector difference components to determine a motion vector difference;
adding the motion vector difference to each of the control point motion vectors to determine final control point motion vectors; and
decoding the block of video data using the final control point motion vectors.

7. The method of claim 1, further comprising:
determining the cost using template matching.

8. The method of claim 7, wherein the block of video data is coded using affine MMVD merge with motion vector difference (MMVD) mode, and wherein determining the cost using template matching comprises:
determining the cost using sub-block based template matching.

9. The method of claim 1, further comprising:
scaling the respective magnitudes of motion vector difference components based on a picture order count (POC) difference.

10. The method of claim 1, further comprising:
displaying a picture that includes the decoded block of video data.

11. An apparatus configured to decode video data, the apparatus comprising:
a memory configured to store a block of video data; and
one or more processors in communication with the memory, the one or more processors configured to:
construct motion vector candidates using possible sign values, respective magnitudes of motion vector difference components, and a motion vector predictor for a block of video data, wherein the possible sign values include a positive sign value and a negative sign value;
sort the motion vector candidates based on a cost for each of the motion vector candidates to create a sorted list;
determine a respective motion vector difference sign for each motion vector difference coordinate based on a motion vector sign predictor index and the sorted list; and
decode the block of video data using the respective magnitudes of motion vector difference coordinates and the respective motion vector difference sign for each motion vector difference component.

12. The apparatus of claim 11, wherein the block of video data is coded using one of inter merge with motion vector difference (MMVD) mode, affine MMVD, geometric partitioning mode (GPM) with MMVD, or multi-hypothesis prediction (MHP) mode.

13. The apparatus of claim 12, wherein the block of video data is coded using inter MMVD mode, and wherein the one or more processors are further configured to:
decode a merge index that indicates the motion vector predictor;
decode a step index that indicates the respective magnitudes of motion vector difference coordinates; and
decode the motion vector sign predictor index.

14. The apparatus of claim 13, wherein the one or more processors are further configured to:
apply the respective motion vector difference sign for each motion vector difference components to the respective magnitudes of the motion vector difference components to determine a motion vector difference;
add the motion vector difference to the motion vector predictor to determine a final motion vector; and
decode the block of video data using the final motion vector.

15. The apparatus of claim 12, wherein the block of video data is coded using affine MMVD mode, the motion vector predictor includes two or three control point motion vectors, and wherein the one or more processors are further configured to:
determine the control point motion vectors;
decode a step index that indicates the respective magnitudes of motion vector difference coordinates; and
decode the motion vector sign predictor index.

16. The apparatus of claim 15, wherein the one or more processors are further configured to:
apply the respective motion vector difference sign for each motion vector difference components to the respective magnitudes of the motion vector difference components to determine a motion vector difference;
add the motion vector difference to each of the control point motion vectors to determine final control point motion vectors; and
decode the block of video data using the final control point motion vectors.

17. The apparatus of claim 11, wherein the one or more processors are further configured to:
determine the cost using template matching.

18. The apparatus of claim 17, wherein the block of video data is coded using affine MMVD merge with motion vector difference (MMVD) mode, and wherein to determine the cost using template matching, the one or more processors are further configured to:
determine the cost using sub-block based template matching.

19. The apparatus of claim 11, wherein the one or more processors are further configured to:
scale the respective magnitudes of motion vector difference components based on a picture order count (POC) difference.

20. The apparatus of claim 11, further comprising:
a display configured to display a picture that includes the decoded block of video data.
